(19) United States
(12) Patent Application Publication
(10) Pub. No.: US 2012/0171534 A1
(43) Pub. Date: Jul. 5, 2012

(54) SEALED SECONDARY BATTERY

(76) Inventors: Shuji Sugimoto, Hyogo (JP); Naoto Kunoike, Osaka (JP); Kyosuke Miyata, Osaka (JP)

(21) Appl. No.: 13/395,001

(22) PCT Filed: Dec. 2, 2010
(86) PCT No.: PCT/JP2010/007023

§ 371 Date: Mar. 8, 2012

(30) Foreign Application Priority Data
Dec. 4, 2009 (JP) 2009-276284

(51) Int. Cl. H01M 10/42; H01M 10/52; H01M 4/02; H01M 4/505; H01M 4/525; H01M 10/04; H01M 2/16; H01M 2/02

(52) U.S. Cl. 429/82; 429/129; 429/94

(57) ABSTRACT

In a sealed secondary battery, an electrode group 1 formed by winding or stacking a positive electrode plate and a negative electrode plate with a porous insulator interposed therebetween is housed in a metal case 4. The metal case 4 has an opening sealed by a sealing plate 6 serving as an electrode terminal. One of the positive electrode plate or the negative electrode plate is connected to the sealing plate 6 through a lead. An upper insulating plate as a stack of a first insulating plate 2 and a second insulating plate 7 having a softening temperature higher than that of the first insulating plate 2 is placed above the electrode group 1. An outer periphery of the upper insulating plate is engaged with an engagement part 9 formed in a side surface of the metal case 4.

### TECHNICAL FIELD

The present disclosure relates to sealed secondary batteries in each of which an electrode group formed by winding or stacking a positive electrode plate and a negative electrode plate with a porous insulator interposed therebetween is housed in a metal case.

### BACKGROUND ART

As sealed secondary batteries, especially sealed secondary batteries for use as power sources for driving small mobile equipment or the like, aqueous electrolyte secondary batteries typified by high capacity alkaline storage batteries and nonaqueous electrolyte secondary batteries typified by lithium ion secondary batteries are known.

These sealed secondary batteries have sealed structures in each of which an electrode group formed by stacking or winding a positive electrode plate and a negative electrode plate with a porous insulator interposed therebetween is housed, together with an electrolyte, in a metal case with insulating plates located above and under the electrode group, respectively, and sandwiched between the electrode group and the metal case and an opening of the metal case is sealed by a sealing plate seals with a gasket interposed therebetween. The sealing plate and the metal case are connected to the positive and negative electrode leads extending from the electrode group, thereby allowing each of the sealing plate and the metal case to serve as an external terminal of the positive or negative electrode.

In a known technique using such a sealed structure, an insulating ring is disposed between the electrode group and the positive electrode lead connected to the sealing plate serving as an external terminal (e.g., a positive electrode terminal), and electrically insulates the positive electrode lead and the electrode group from each other (see, for example, Patent Document 1). This insulating ring has a rising edge projecting toward the opening of the metal case. This rising edge prevents the positive electrode lead which is bent when being housed, from being in contact with the metal case (i.e., the negative electrode) in error.

Patent Document 2 proposes a structure in which an insulating plate placed above the electrode group is made of a laminated plate of phenol resin containing an inorganic additive. This insulating plate contracts to a small degree when being cured with heat, and thus, has a uniform thickness and is not warped, thereby preventing deformation of an electrode plate during overcharge.

### CITATION LIST

### Patent Document

PATENT DOCUMENT 1: Japanese Patent Publication No. H11-31487
PATENT DOCUMENT 2: Japanese Patent Publication No. 2002-231314

### SUMMARY OF THE INVENTION

### Technical Problem

An insulating ring with a structure as described in Patent Document 1 is effective at electrically insulating a positive electrode lead and an electrode group from each other and a metal case (i.e., a negative electrode) and the positive electrode lead from each other, and is made of a material such as a polyethylene resin or a polypropylene resin with good punching processability. Such resins, however, have low thermal resistances (i.e., low softening temperatures). Thus, when high-temperature and high-pressure gas is generated in a secondary battery in abnormal situations such as overcharge, the insulating ring might be softened to cause the electrode group from protruding out of the battery, destroying the sealing plate because of the high-temperature gas. In particular, in a case where a nickel-based material having a larger capacity per a unit mass than a cobalt-based material is used as a positive electrode active material, the amount of gas generated in abnormal situations is about three times as large as that in the case of using the cobalt-based material, and thus, the above problems might occur.

In addition, the insulating plate described in Patent Document 2 not only contracts to a small degree when being cured with heat but also has high thermal resistance. Such an insulating plate, however, has poor punching processability, and thus, it is difficult to provide a rising edge as described in Patent Document 1. Accordingly, a positive electrode lead which is bent when being housed might come in contact with a metal case (i.e., a negative electrode) in error to cause a short-circuit. In particular, in a case where the outer diameter of the battery is reduced (e.g., from 18 mm to 14 mm), this trouble might occur.

It is therefore a principal object of the present disclosure to provide a secondary battery which can reduce contact between a lead and each of an electrode group and a metal case, and can prevent protrusion of the electrode group even in abnormal situations such as overcharge.

### Solution to the Problem

To achieve the object, a sealed secondary battery according to the present disclosure has a structure in which an electrode group formed by winding or stacking a positive electrode plate and a negative electrode plate with a porous insulator interposed therebetween is housed in a metal case, the metal case has an opening sealed by a sealing plate serving as an electrode terminal, one of the positive electrode plate or the negative electrode plate is connected to the sealing plate through a lead, an upper insulating plate as a stack of a first insulating plate and a second insulating plate having a softening temperature higher than that of the first insulating plate is placed above the electrode group, and an outer periphery of the upper insulating plate is engaged with an engagement part formed in a side surface of the metal case.

With this structure, the upper insulating plate above the electrode group can electrically insulate the lead and the electrode group from each other and prevent a lead which is bent when being housed, from being in contact with the metal case in error, and the second insulating plate constituting the upper insulating plate and having a high softening temperature can prevent the electrode group from destroying the sealing plate and protruding out of the battery because of high-temperature and high-pressure gas generated in the battery in abnormal situations such as overcharge of the battery.

### Advantages of the Invention

According to the present disclosure, a sealed secondary battery capable of preventing contact between a lead and each of an electrode group and a metal case and also preventing protrusion of the electrode group even in abnormal situations such as overcharge.

### BRIEF DESCRIPTION OF THE DRAWINGS

FIG. 1 A cross-sectional view schematically illustrating a cylindrical lithium ion secondary battery according to an embodiment of the present disclosure.

FIG. 2 A perspective view illustrating a heat-resistant protective plate according to the embodiment of the present disclosure.

FIG. 3 A perspective view illustrating an insulating plate according to the embodiment of the present disclosure.

FIG. 4 A perspective view illustrating an insulating plate and a heat-resistant protective plate according to another embodiment of the present disclosure.

FIG. 5 A side view illustrating the insulating plate and the heat-resistant protective plate according to another embodiment of the present disclosure.

FIG. 6 A perspective view illustrating an insulating plate and a heat-resistant protective plate according to another embodiment of the present disclosure.

FIG. 7 A perspective view illustrating a heat-resistant protective plate according to another embodiment of the present disclosure.

FIG. 8 A perspective view illustrating an insulating plate when viewed from a heat-resistant protective plate in another embodiment of the present disclosure.

FIG. 9 A perspective view illustrating an insulating plate when viewed from a heat-resistant protective plate according to another embodiment of the present disclosure.

### DESCRIPTION OF EMBODIMENTS

A sealed secondary battery according to an embodiment of the present disclosure is a sealed secondary battery in which an electrode group formed by winding or stacking a positive electrode plate and a negative electrode plate with a porous insulator interposed therebetween is housed in a metal case. An opening of the metal case is sealed by a sealing plate serving as an electrode terminal. One of the positive electrode plate or the negative electrode plate is connected to the sealing plate through a lead. An upper insulating plate as a stack of a first insulating plate and a second insulating plate having a softening temperature higher than that of the first insulating plate is provided above the electrode group. The outer periphery of the upper insulating plate is engaged with an engagement part formed in a side surface of the metal case.

In a preferred embodiment, the softening temperature of the second insulating plate is 250° C. or more.

In a preferred embodiment, the first insulating plate is made of a polyolefin-based resin or a polyimide-based resin, and the second insulating plate is a phenol resin laminated plate using glass cloth as a base and containing an inorganic additive.

In a preferred embodiment, the inorganic additive is made of at least a material selected from the group consisting of alumina, silica, aluminium hydroxide, calcium hydroxide, magnesium hydroxide, and calcium carbonate.

In a preferred embodiment, the first insulating plate has a rising edge projecting toward the opening of the metal case.

In a preferred embodiment, the engagement part is a groove formed by deforming the side surface of the metal case, and the outer periphery of the upper insulating plate is engaged with a lower portion of the groove formed in the side surface of the metal case.

In a preferred embodiment, a positive electrode active material of the positive electrode plate is a lithium nickel-based oxide or a lithium nickel manganese-based oxide.

In a preferred embodiment, the metal case has an outer diameter of 14 mm or less.

In a preferred embodiment, a recess is formed in a surface of the first insulating plate, and the second insulating plate is fitted in the recess.

In a preferred embodiment, a gas vent or a gas path is formed in a surface of at least one of the first insulating plate or the second insulating plate, and the surface in which the gas vent or the gas path is formed faces the other one of the first insulating plate or the second insulating plate.

A sealed secondary battery according to a preferred embodiment has the following structure. An electrode group formed by stacking or winding a positive electrode plate and a negative electrode plate with a porous insulator interposed therebetween is housed, together with an electrolyte, in a metal case with insulating plates located above and under the electrode group, respectively, and sandwiched between the electrode group and the metal case. The metal case has an opening sealed by a sealing plate with a gasket interposed between the opening and the sealing plate. A heat-resistant protective plate is provided on the lower surface of the insulating plate located above the electrode group. The heat-resistant protective plate does not close an injection hole, a lead extraction hole, and gas vents formed in the insulating plate, and is made of an insulating material having high thermal resistance. This heat-resistant protective plate can prevent deformation and protrusion of the electrode group even under high temperatures in abnormal situations such as overcharge.

In a preferred embodiment, the insulating plate and the heat-resistant protective plate are coupled to each other by a fitting part. A fitting recess is formed in the insulating plate, and the heat-resistant protective plate is fitted in this fitting recess. Accordingly, the heat-resistant protective plate and the insulating plate can be coupled to each other without closing the injection hole, the lead extraction hole, and the gas vents formed in the insulating plate, and the components can be easily assembled.

In a preferred embodiment, a positioning projection provided on the insulating plate and a coupling hole provided in the heat-resistant protective plate can be used for positioning. In this manner, the heat-resistant protective plate and the insulating plate can be coupled to each other without closing the injection hole, the lead extraction hole, and the gas vents formed in the insulating plate, and the components can be easily assembled.

In a preferred embodiment, a gas channel is provided in a portion where the insulating plate and the heat-resistant protective plate overlap each another. The gas channel provided in a portion where the insulating plate and the heat-resistant protective plate overlap each another, can efficiently release a large amount of gas generated in the battery in abnormal situations such as overcharge.

In a preferred embodiment, a gas channel is provided in a portion of at least one of the insulating plate or the heat-resistant protective plate where the insulating plate and the heat-resistant protective plate overlap each another. The gas channel provided in a portion where the insulating plate and the heat-resistant protective plate overlap each other, can efficiently release a large amount of gas generated in the battery in abnormal situations such as overcharge.

In a preferred embodiment, a projection is provided in a portion of at least one of the insulating plate or the heat-resistant protective plate where the insulating plate and the heat-resistant protective plate overlap each another. Then, a gas channel is formed in a portion where the insulating plate and the heat-resistant protective plate overlap each other, thereby efficiently releasing a large amount of gas generated in the battery in abnormal situations such as overcharge.

Embodiments of the present disclosure will be described hereinafter with reference to the drawings. The present disclosure is not limited to the following embodiments. Various changes and modifications may be made without departing from the scope of the present invention, and the following embodiments may be combined as necessary.

FIG. 1 is a cross-sectional view schematically illustrating a cylindrical lithium ion secondary battery according to an embodiment of the present disclosure.

As illustrated in FIG. 1, in the lithium ion secondary battery of this embodiment, an electrode group 1 formed by winding or stacking a positive electrode plate and a negative electrode plate with a porous insulator interposed therebetween is housed in a metal case 4. An opening of the metal case 4 is sealed by a sealing plate 6 serving as an electrode terminal. One of the positive electrode plate or the negative electrode plate is connected to the sealing plate 6 through a lead 8. An upper insulating plate as a stack of a first insulating plate 2 and a second insulating plate (hereinafter also referred to as a “heat-resistant protective plate”) 7 having a softening temperature higher than that of the first insulating plate 2 is placed above the electrode group 1. The outer periphery of the upper insulating plate is engaged with an engagement part 9 formed on the side surface of the metal case 4.

In the following description, as an example, the sealing plate 6 serves as a positive electrode terminal, and the metal case 4 serves as a negative electrode terminal, for simplicity of explanation.

In this structure, the upper insulating plate above the electrode group 1 can electrically insulate an positive electrode lead 8 and the electrode group 1 from each other, and prevent the positive electrode lead 8 which is bent when being housed, from being in contact with the metal case 4 in error. In addition, the second insulating plate 7 constituting the upper insulating plate and having a high softening temperature can prevent the electrode group 1 from destroying the sealing plate 6 and protruding out of the secondary battery because of high-temperature and high-pressure gas generated in the battery in abnormal situations such as overcharge of the battery.

Here, the softening temperature of the second insulating plate 7 is preferably 250° C. or more. In the case of a lithium ion secondary battery, the temperature of a gas generated in the battery in abnormal situations such as overcharge increases to about 250° C. The softening temperature of the second insulating plate 7 is higher than this gas temperature, i.e., 250° C., and thus, the second insulating plate 7 is not softened even when being exposed to a high-temperature gas. Accordingly, since the outer periphery of the upper insulating plate is engaged with the engagement part 9 formed on the side surface of the metal case 4, the second insulating plate 7 can prevent protrusion of the electrode group 1 even under high internal pressures of the battery.

The gas generated in abnormal situations increases to 250° C. or more for a moment in some cases. However, even in these cases, operation of the safety valve of the battery can reduce the internal temperature of the battery. Accordingly, even if a gas having a temperature higher than the softening temperature of the second insulating plate 7 is generated in the battery, the second insulating plate 7 is not instantly softened, and the advantage of preventing protrusion of the electrode group 1 by the second insulating plate 7 can be ensured.

The material for the first insulating plate 2 is not specifically limited as long as the material has resistance to an electrolyte. For example, the first insulating plate 2 is preferably made of a polyolefin-based resin or a polyimide-based resin. These resins have good punching processability. Thus, a rising edge projecting toward the opening of the metal case 4 can be easily formed on the first insulating plate 2. This structure can effectively prevent the positive electrode lead 8 which is bent when being housed, from being in contact with the metal case 4 in error.

In addition, the material for the second insulating plate is not specifically limited as long as the material is resistant to an electrolyte and has a softening temperature of 250° C. or more. The second insulating plate preferably is preferably a phenol resin laminated plate using glass cloth as a base and containing an inorganic additive. This material has a softening temperature as high as 250° C. For example, even when the secondary battery reaches thermal runaway to have its internal temperature increased to about 250° C., protrusion of the electrode group 1 can be prevented by the second insulating plate 7.

The engagement part 9 may be a groove formed by extruding the side surface of the metal case 4, for example. In this case, the outer periphery of the upper insulating plate is engaged with a lower portion of the groove 9 formed in the side surface of the metal case 4.

The type of the sealed secondary battery is not specifically limited. For example, in the case of a lithium ion secondary battery, advantages of the present disclosure can be more effectively obtained by using a lithium nickel-based oxide or a lithium nickel manganese-based oxide as a positive electrode active material of the positive electrode plate. In the case of using a nickel-based material as a positive electrode active material, the amount of gas generated in abnormal situations is about three times as large as that in the case of using cobalt-based material. Even in such a case, protrusion of the electrode group 1 can be effectively prevented by the second insulating plate 7.

The outer diameter of the metal case 4 is not specifically limited. For example, in a case where the outer diameter of 14 mm or less, advantages of the present disclosure can be more effectively obtained. In a case where the second insulating plate 7 is the above-described phenol resin laminated plate using glass cloth as a base and containing an inorganic additive, this second insulating plate 7 has poor punching processability, and it is difficult to provide a rising edge on the second insulating plate 7. However, in a case where the first insulating plate 2 is made of the above material such as a polyolefin resin, good punching processability can be ensured, and a rising edge can be easily formed on the first insulating plate 2. Accordingly, even in a case where the outer diameter of the metal case 4 is reduced to 14 mm or less, the rising edge on the first insulating plate 2 can effectively prevent a short-circuit caused by erroneous contact of the positive electrode lead, which is bent when being housed, with the metal case (i.e., the negative electrode).

The “softening temperature” herein is a temperature measured by thermomechanical analysis (TMA) described in JIS-K7196-1991.

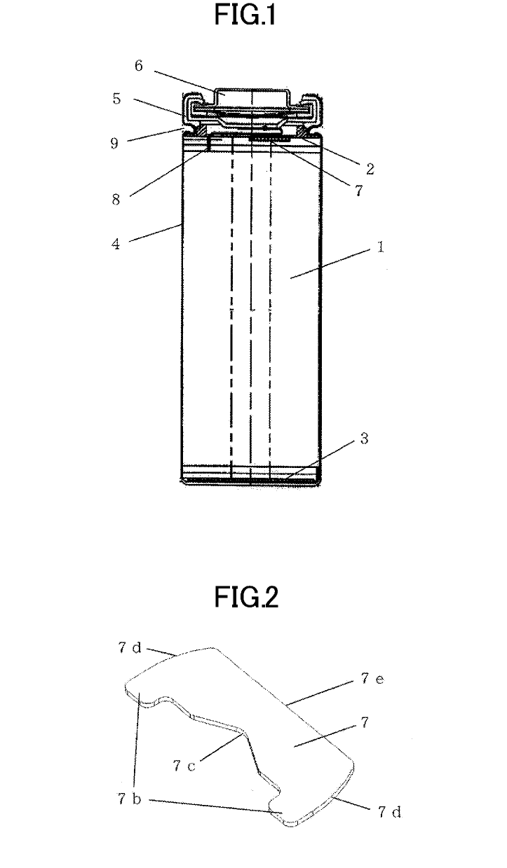

Referring now to FIGS. 2-9, a specific structure of the lithium ion secondary battery of this embodiment will be described.

FIG. 2 is a perspective view illustrating the heat-resistant protective plate (the second insulating plate) 7. A V-shaped notch 7c is formed in the middle of the heat-resistant protective plate 7 not to close an injection hole 2a in the first insulating plate 2. A linear portion 7e is also provided as a hole for extracting the positive electrode lead 8. The outer periphery of the second insulating plate 7 has curved portions 7d along the inner periphery of the cylindrical lithium ion secondary battery. The heat-resistant protective plate 7 also has projections 7b located at the outer periphery and projecting toward the negative electrode. With this structure, the heat-resistant protective plate 7 is positioned without rotating in the cylindrical lithium ion secondary battery.

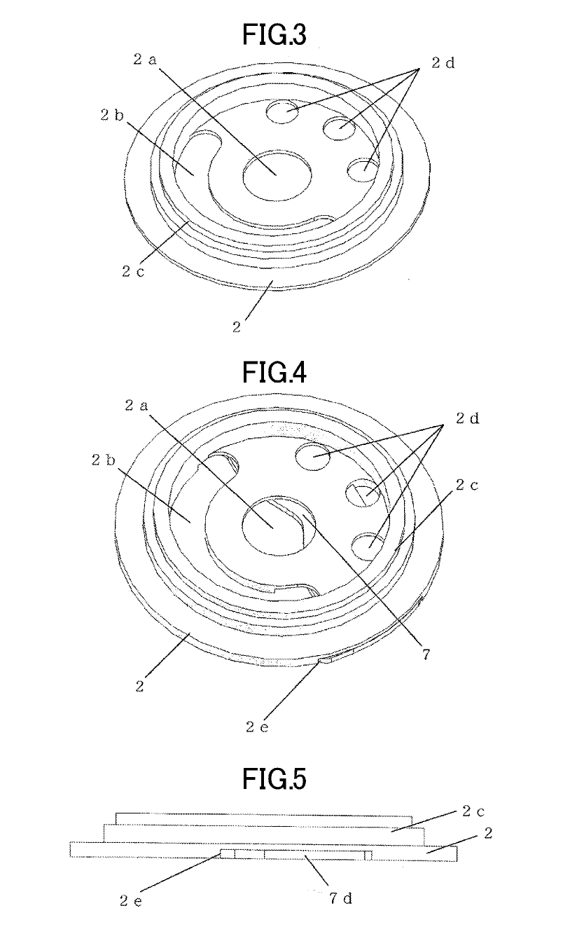

FIG. 3 is a perspective view illustrating the first insulating plate 2. A circular injection hole 2a is provided at the center of the first insulating plate 2. An electrolyte is poured in the electrode group through this injection hole 2a. The positive electrode lead 8 extending from the electrode group 1 needs to be welded to the sealing plate 6, and a lead extraction hole 2b of the first insulating plate 2 is provided for this welding. Three gas vents 2d are provided in the first insulating plate 2 in order to efficiently release a large amount of gas generated in the battery in abnormal situations such as overcharge. A cylindrical rising edge 2c electrically insulates the groove 9 of the metal case 4 from the positive electrode lead 8.

The heat-resistant protective plate 7 is preferably coupled to the first insulating plate 2 by fitting in the manner as illustrated in FIGS. 4 and 5. A fitting recess 2e formed in the first insulating plate 2 allows the curved portions 7d at both ends of the heat-resistant protective plate 7 to be fitted therein, and thereby, the heat-resistant protective plate 7 and the first insulating plate 2 are positioned. In this structure, the injection hole 2a, the lead extraction hole 2b, and the gas vents 2d formed in the first insulating plate 2 are not closed, and are maintained as intended.

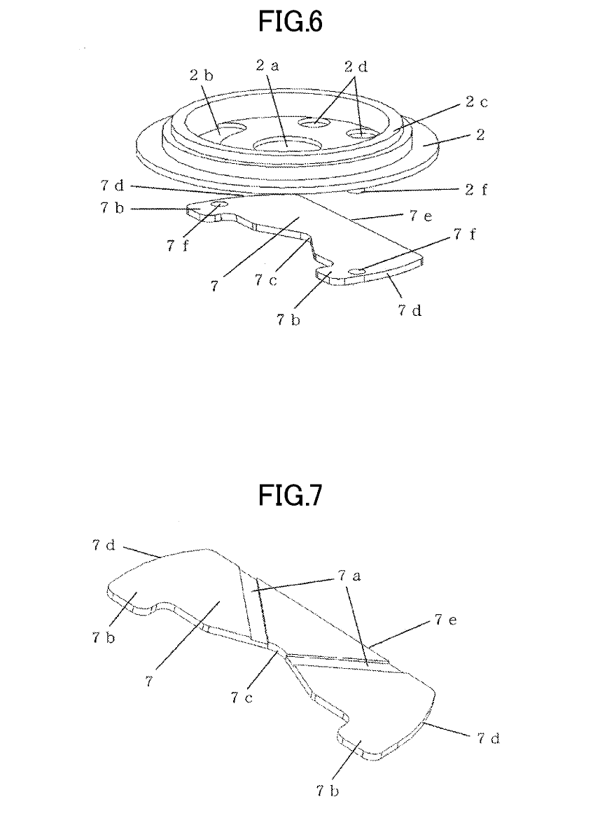

The heat-resistant protective plate 7 is preferably positioned relative to the first insulating plate 2 having positioning projections 2f illustrated in FIG. 6. Specifically, coupling holes 7f in which the positioning projections 2f of the first insulating plate 2 are fitted are provided in the heat-resistant protective plate 7, thereby positioning the heat-resistant protective plate 7 and the first insulating plate 2 relative to each other by fitting. In this manner, it is possible to position the heat-resistant protective plate 7 and the first insulating plate 2 without closing the three types of holes of the injection hole 2a, the lead extraction hole 2b, and the gas vents 2d formed in the first insulating plate 2 as intended.

In addition, the heat-resistant protective plate 7 preferably has gas channels 7a illustrated in FIG. 7. The gas channel provided in part of the second insulating plate 7 where the second insulating plate 7 overlaps the first insulating plate 2 can efficiently release a large amount of gas generated in the battery in abnormal situations such as overcharge.

Further, gas channels 2g as illustrated in FIG. 8 are preferably provided in at least one of the first insulating plate 2 or the heat-resistant protective plate 7. In this structure, the gas channels provided in portions where the first insulating plate 2 and the heat-resistant protective plate 7 overlap each other can effectively release a large amount of gas generated in the battery in abnormal situations such as overcharge.

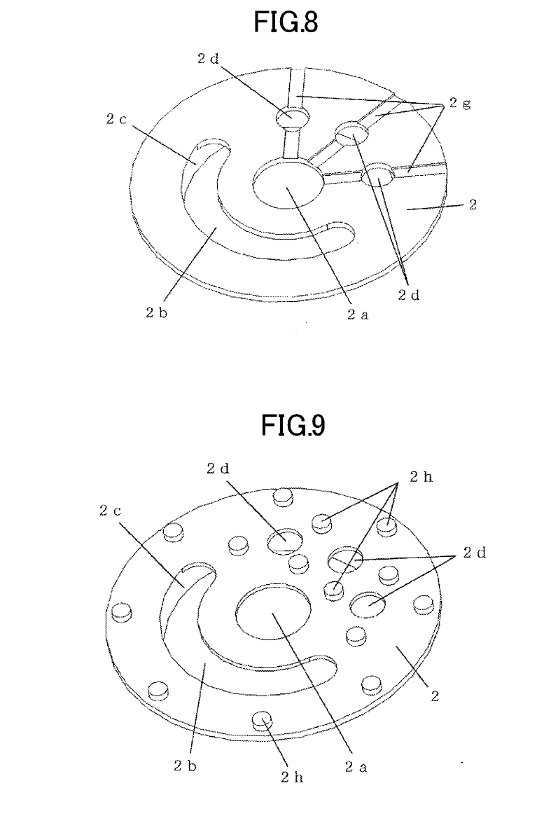

Furthermore, projections 2h as illustrated in FIG. 9 are preferably provided on at least one of the first insulating plate 2 or the heat-resistant protective plate 7. In this structure, gas channels are formed in portions where the first insulating plate 2 and the heat-resistant protective plate 7 overlap each other, thereby effectively releasing a large amount of gas generated in the battery in abnormal situations such as overcharge.

In this embodiment, the cylindrical lithium secondary battery has been described. However, the present disclosure is not limited to lithium secondary batteries, and is applicable to alkaline storage batteries. In such a case, substantially the same advantages can also be obtained.

### EXAMPLES

### First Example

Examples of the present disclosure will be described with reference to the drawings. An electrode group 1 was formed by stacking or winding a positive electrode plate and a negative electrode plate with a porous insulator interposed therebetween, and the electrode group 1 and an electrolyte were housed in a metal case 4 with first insulating plates 2 and 3 interposed between the electrode group 1 and the metal case 4 and located above and below the electrode group 1, respectively. In this manner, a cylindrical lithium ion secondary battery was fabricated. As an insulation structure above the electrode group 1, the second insulating plate 7 illustrated in FIG. 2 and the first insulating plate 2 illustrated in FIG. 3 were used. The metal case 4 had an outer diameter of 14 mm.

The positive electrode plate was obtained in the following manner. First, material mixture slurry in which a positive electrode active material, a binder, and as necessary, a conductive material and a thickener, were kneaded and dispersed in a solvent, was applied onto a single surface or both surfaces of a current collector, and was dried and rolled, thereby forming an active material layer. This active material layer had a plain portion to which a positive electrode lead was welded. Here, as the positive electrode active material, LiNi_{0.8}Co_{0.15}Al_{0.05}O₂, which is a lithium nickel-based oxide, was used.

The negative electrode plate was obtained in the following manner. First, material mixture slurry in which a negative electrode active material, a binder, and as necessary, a conductive material were kneaded and dispersed in an organic solvent, was applied onto a single surface of the current collector, and was dried and rolled, thereby forming an active material layer. This active material layer had a plain portion to which a negative electrode lead was welded.

A separator serving as a porous insulator was made of a polyethylene resin or a polypropylene resin having a thickness of 15 μm to 30 μm, or a mixture of these resins.

The nonaqueous electrolyte can be adjusted by dissolving an electrolyte material in a nonaqueous solvent. The nonaqueous solvent may be, for example, ethylene carbonate, propylene carbonate, or butylene carbonate. These nonaqueous solvents may be used solely or two or more of these nonaqueous solvents may be mixed as a solvent mixture.

The heat-resistant protective plate 7 was placed above the electrode group 1. The first insulating plate 2 was placed above the heat-resistant protective plate 7. A lower insulating plate 3 was placed on the bottom of the electrode group 1.

The heat-resistant protective plate 7 was a phenol resin laminated plate using glass cloth as a base and containing an inorganic additive. The glass fiber diameter of the glass cloth is preferably about 4 μm to about 15 μm in terms of strength, compatibility, and cost, for example. The inorganic additive having an average particle size smaller than the glass fiber diameter of the glass cloth was used. When phenol resin is heated in order to cure the phenol resin by heat, the phenol resin is melted and flows. At this time, the use of the inorganic additive having an average particle size smaller than the glass fiber diameter prevents inhibition of the flow of the inorganic additive by glass cloth fibers. Accordingly, a phenol resin laminated plate having a uniform composition and showing no warpage can be obtained. Such an inorganic additive capable of inhibiting thermosetting of phenol resin when being used with glass cloth is preferably at least a material selected from the group consisting of alumina, silica, aluminium hydroxide, calcium hydroxide, magnesium hydroxide, and calcium carbonate.

Examples of phenol resin include phenol resin powder and phenol resin varnish. In particular, phenol resin varnish is preferable in terms of impregnating ability to glass phenol.

The phenol resin laminated plate can be formed in the following manner. Prepregs in each of which glass cloth is impregnated with phenol varnish including an inorganic additive are prepared. A predetermined number of prepregs described above are stacked, and subjected to heat and pressure, thereby forming a phenol resin laminated plate. In this process, the heating temperature is preferably 150° C. to 200° C., the pressure is preferably 3 MPa to 7 MPa, and the period is preferably 60 minutes to 150 minutes.

The first insulating plate 2 is preferably made of a conventionally used a polyolefin resin, such as a polyethylene resin or a polypropylene resin, which is resistant to an electrolyte and has good punching processability.

### Second Example

A lithium ion battery in which a first insulating plate 2 coupled to a second insulating plate 7 by fitting with a fitting recess 2e was placed above an electrode group 1, as illustrated in FIGS. 4 and 5, was prepared as a second example.

### Third Example

A lithium ion battery in which a heat-resistant protective plate 7 having coupling holes 7f and a first insulating plate 2 positioned by positioning projections 2f as illustrated in FIG. 6 were placed above an electrode group 1 was prepared as a third example.

### Fourth Example

A lithium ion battery in which a first insulating plate 2 as illustrated in FIG. 3 and gas channels 7a as illustrated in FIG. 7 were placed above an electrode group 1 was prepared as a fourth example.

### Fifth Example

A lithium ion battery in which an insulating plate having gas channels 2g for releasing gas as illustrated in FIG. 8 and a heat-resistant protective plate 7 as illustrated in FIG. 2 were placed above an electrode group 1 was prepared as a fifth example.

### Sixth Example

A lithium ion battery in which a first insulating plate 2 having projections 2h as illustrated in FIG. 9 and a second insulating plate 7 as illustrated in FIG. 2 were placed above an electrode group 1 was prepared as a sixth example.

### First Comparative Example

As a first comparative example, a battery was prepared in the same manner as the first example except that the heat-resistant protective plate 7 was not included in the first insulating plate 2 placed above the electrode group 1.

As a method for comparison, an overcharge test and a combustion test on the assumption of abnormal situations were performed on five cells of each of the examples and the comparative example. The results are shown in Table 1 where the state in which the sealing plate is destroyed in the test to cause the electrode group 1 to protrude out of the battery is defined as “rupture,” the battery showing rupture is indicated by “rupture,” and a battery showing no rupture is indicated by “no rupture.”

TABLE 1

| | Overcharge test | Combustion test |
|---|---|---|
| First example | No rupture | No rupture |
| Second example | No rupture | No rupture |
| Third example | No rupture | No rupture |
| Fourth example | No rupture | No rupture |
| Fifth example | No rupture | No rupture |
| Sixth example | No rupture | No rupture |
| First comparative example | Rupture of one cell | Rupture of three cells |

As shown in Table 1, the batteries of the first through fourth examples in each of which the first insulating plate 2 and the heat-resistant protective plate 7 were placed above the electrode group 1 showed no ruptures. This is because the heat-resistant protective plate 7 pressed the electrode group 1 even in abnormal situations such as overcharge or combustion.

On the other hand, the battery of the first comparative example including no heat-resistant protective plate 7 could not suppress protrusion of the electrode group 1 to cause rupture.

### INDUSTRIAL APPLICABILITY

The present disclosure is useful for power sources for driving automobiles, electric motorcycles, or electric play equipment, for example.

### DESCRIPTION OF REFERENCE CHARACTERS

1 electrode group
2 first insulating plate
2a injection hole
2b lead extraction hole
2c rising edge
2d gas vent
2e fitting recess
2f positioning projection
2g gas channel
2h projection
3 lower insulating plate
4 metal case
5 gasket
6 sealing plate
7 second insulating plate (heat-resistant protective plate)
7a gas channel
7b projection
7d curve
7d curved portion
7e linear portion
7f coupling hole
8 positive electrode lead
9 engagement part (groove)

1. A sealed secondary battery in which an electrode group formed by winding or stacking a positive electrode plate and a negative electrode plate with a porous insulator interposed therebetween is housed in a metal case, wherein
the metal case has an opening sealed by a sealing plate serving as an electrode terminal,
one of the positive electrode plate or the negative electrode plate is connected to the sealing plate through a lead,
an upper insulating plate as a stack of a first insulating plate and a second insulating plate having a softening temperature higher than that of the first insulating plate is placed above the electrode group, and
an outer periphery of the upper insulating plate is engaged with an engagement part formed in a side surface of the metal case.

2. The sealed secondary battery of claim 1, wherein
the softening temperature of the second insulating plate is 250° C. or more.

3. The sealed secondary battery of claim 1, wherein
the first insulating plate is made of a polyolefin-based resin or a polyimide-based resin, and
the second insulating plate is a phenol resin laminated plate using glass cloth as a base and containing an inorganic additive.

4. The sealed secondary battery of claim 3, wherein
the inorganic additive is made of at least a material selected from the group consisting of alumina, silica, aluminium hydroxide, calcium hydroxide, magnesium hydroxide, and calcium carbonate.

5. The sealed secondary battery of claim 1, wherein
the first insulating plate has a rising edge projecting toward the opening of the metal case.

6. The sealed secondary battery of claim 1, wherein
the engagement part is a groove formed by deforming the side surface of the metal case, and
the outer periphery of the upper insulating plate is engaged with a lower portion of the groove formed in the side surface of the metal case.

7. The sealed secondary battery of claim 1, wherein
the sealed secondary battery is a lithium ion secondary battery, and
a positive electrode active material of the positive electrode plate is a lithium nickel-based oxide or a lithium nickel manganese-based oxide.

8. The sealed secondary battery of claim 1, wherein
the metal case has an outer diameter of 14 mm or less.

9. The sealed secondary battery of claim 1, wherein
a recess is formed in a surface of the first insulating plate, and
the second insulating plate is fitted in the recess.

10. The sealed secondary battery of claim 1, wherein
a gas vent or a gas path is formed in a surface of at least one of the first insulating plate or the second insulating plate, and
the surface in which the gas vent or the gas path is formed faces the other one of the first insulating plate or the second insulating plate.
